(19) United States
(12) Patent Application Publication
(10) Pub. No.: US 2024/0262132 A1
(43) Pub. Date: Aug. 8, 2024

(54) TIRE

(71) Applicant: BRIDGESTONE CORPORATION, Chuo-ku, Tokyo (JP)

(72) Inventor: Takashi SHIMURA, Chuo-ku, Tokyo (JP)

(73) Assignee: BRIDGESTONE CORPORATION, Chuo-ku, Tokyo (JP)

(21) Appl. No.: 18/562,981

(22) PCT Filed: Nov. 18, 2021
(86) PCT No.: PCT/JP2021/042504

§ 371 Date: Nov. 21, 2023

(30) Foreign Application Priority Data
Jun. 30, 2021 (JP) 2021-109739

(51) Int. Cl. B60C 9/08; B60C 5/00; B60C 9/17; B60C 19/00

(52) U.S. Cl. CPC B60C 9/08; B60C 9/17; B60C 19/00; B60C 5/00

(57) ABSTRACT

A tire according to the present disclosure comprises a carcass extending between a first bead core in a first half portion of the tire and a second bead core in a second half portion of the tire. The carcass comprises a body portion, a first foldback portion extending from the body portion and folding back around the first bead core, and a second foldback portion extending from the body portion and folding back around the second bead core. A first end of the first foldback portion is positioned further to the tire radial direction outer side than a second end of the second foldback portion in the tire radial direction. A communication device is embedded in a sidewall portion of the first half portion, further to the tire radial direction inner side than the first end and further to the tire radial direction outer side than the second end.

### TECHNICAL FIELD

The present disclosure relates to a tire.

### BACKGROUND

A configuration in which a communication device such as an RF tag is embedded in a tire is known. For example, Patent Literature (PTL) 1 describes a tire with an RF tag disposed in a sidewall portion of the tire.

### CITATION LIST

### Patent Literature

PTL 1: JP 2020-55450 A

### SUMMARY

### Technical Problem

With conventional tires, when a load is applied to a tire, a communication device installed therein may be damaged due to the load applied to the communication device. Therefore, there is still a need to improve the durability of the communication device disposed in the tire.

In view of these circumstances, it would be helpful to provide a tire that improves the durability of a communication device disposed in the tire.

### Solution to Problem

A tire according to the present disclosure includes a first half portion on a vehicle installation outer side and a second half portion on a vehicle installation inner side with respect to a tire equatorial plane and comprises a carcass that extends between a first bead core positioned in the first half portion and a second bead core positioned in the second half portion. The carcass comprises: a carcass body portion that extends toroidally between the first bead core and the second bead core; a first carcass foldback portion that extends from the carcass body portion, folds back around a perimeter of the first bead core from a tire width direction inner side to a tire width direction outer side, and extends to a tire radial direction outer side; and a second carcass foldback portion that extends from the carcass body portion, folds back around a perimeter of the second bead core from the tire width direction inner side to the tire width direction outer side, and extends to the tire radial direction outer side. A first end of the tire radial direction outer side of the first carcass foldback portion is positioned further to the tire radial direction outer side than a second end of the tire radial direction outer side of the second carcass foldback portion. A communication device is embedded in a sidewall portion of the first half portion, further to the tire radial direction inner side than the first end and further to the tire radial direction outer side than the second end.

### Advantageous Effect

According to the present disclosure, a tire that improves the durability of a communication device disposed in the tire can be provided.

### BRIEF DESCRIPTION OF THE DRAWINGS

In the accompanying drawings:

FIG. 1 is a cross-sectional view, in a tire width direction, of a tire according to a first embodiment of the present disclosure;

FIG. 2 is a cross-sectional view, in a tire width direction, of a first example of a modification to the of the tire illustrated in FIG. 1;

FIG. 3 is a cross-sectional view, in a tire width direction, of a second example of a modification to the tire illustrated in FIG. 1; and

FIG. 4 is a cross-sectional view, in a tire width direction, of a tire according to a second embodiment of the present disclosure.

### DETAILED DESCRIPTION

The following describes embodiments of a tire according to the present disclosure, with reference to the drawings. Members and portions that are common to each drawing use the same reference signs. Note, however, that the drawings are schematic and that the proportions of each dimension and the like may differ from those in reality.

In the present specification, “tire width direction” refers to a direction parallel to a rotation axis of the tire. “Tire radial direction” refers to a direction perpendicular to the rotation axis of the tire. “Tire circumferential direction” refers to a direction in which the tire rotates centered on the rotation axis of the tire.

Further, in the present specification, “tire radial direction inner side” refers to a side along the tire radial direction closer to the rotation axis of the tire, and “tire radial direction outer side” refers to a side along the tire radial direction farther from the rotation axis of the tire. On the other hand, “tire width direction inner side” refers to a side along the tire width direction closer to a tire equatorial plane, denoted as CL, and “tire width direction outer side” refers to a side along the tire width direction farther from the tire equatorial plane CL.

In the present specification, the “tire equatorial plane” is a plane, in a cross section in the tire width direction of the tire, that is perpendicular to a bead line at a midpoint of the bead line, the bead line being a straight line connecting centers of a pair of bead cores.

Unless otherwise noted, in the present specification, the positional relationship or the like of each element of the tire is measured in a standard state. The “standard state” is a state in which the tire is fitted to a rim of a wheel that is an applicable rim, a prescribed internal pressure is applied, and no load is applied. The following describes a tire that has a cavity filled with air and is installed on a vehicle such as a passenger vehicle. However, the cavity of the tire may be filled with a fluid other than air, and the tire may be installed on a vehicle other than a passenger vehicle.

In the present specification, “applicable rim” (Measuring Rim in the STANDARDS MANUAL of ETRTO and Design Rim in the YEAR BOOK of TRA) refers to an approved rim of an applicable size as described by, or as described in the future by, valid industrial standards for the region in which a tire is produced or used, such as the JATMA YEAR BOOK of JATMA (the Japan Automobile Tyre Manufacturers Association) in Japan, the STANDARDS MANUAL of ETRTO (European Tyre and Rim Technical Organization) in Europe, and the YEAR BOOK of TRA (The Tire and Rim Association, Inc.) in the U.S. In a case in which a rim size is not described in the industrial standards, the “applicable rim” refers to a rim with a width corresponding to a bead width of the pneumatic tire. The “applicable rim” includes current sizes as well as sizes that will be included in the future in the above industrial standards. Examples of “sizes described in the future” may include sizes as described in “FUTURE DEVELOPMENTS” in the 2013 edition of the STANDARDS MANUAL of ETRTO.

In the present specification, “prescribed internal pressure” refers to an air pressure (maximum air pressure) corresponding to the maximum load capability of a single wheel in an applicable size and ply rating as described in the JATMA YEAR BOOK or other industrial standards. In case of a size not described in the above industrial standard, the “prescribed internal pressure” refers to an air pressure (the maximum air pressure) corresponding to the maximum load capability prescribed for each vehicle on which the tire is installed. Furthermore, in the present specification, “prescribed load” refers to a load corresponding to the maximum load capability of a single wheel in an applicable size and ply rating as described in the above industrial standards. In case of a size not described in the above industrial standards, the “prescribed load” refers to a load corresponding to the maximum load capability prescribed for each vehicle on which the tire is installed.

### First Embodiment

The following describes a tire 1 according to a first embodiment of the present disclosure, with reference to the drawings.

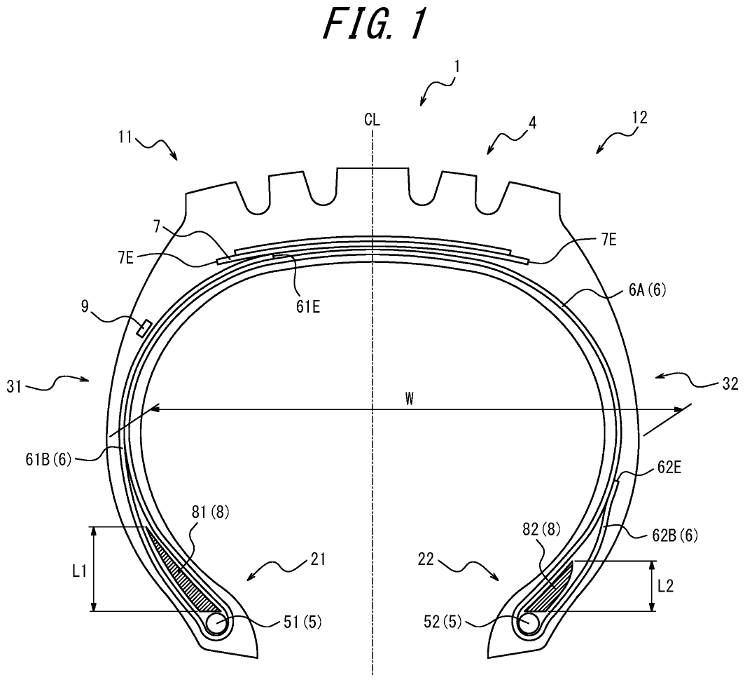

FIG. 1 is a cross-sectional view, cut along the tire width direction, of the tire 1 according to the first embodiment of the present disclosure.

The tire 1 includes a first half portion 11 on a vehicle installation outer side and a second half portion 12 on a vehicle installation inner side, with respect to the tire equatorial plane CL. In the present specification, “vehicle installation outer side” of the tire 1 refers to a side of the tire 1 that is farther from the center of a vehicle when the tire 1 is installed on the vehicle, and “vehicle installation inner side” of the tire 1 refers to a side of the tire 1 that is closer to the center of the vehicle when the tire 1 is installed on the vehicle.

The tire 1 has a pair of bead portions 2, a pair of sidewall portions 3, and a tread portion 4. The sidewall portions 3 extend between the tread portion 4 and the bead portions 2. The pair of bead portions 2 includes a first bead portion 21 positioned in the first half portion 11 and a second bead portion 22 positioned in the second half portion 12. The pair of sidewall portions 3 includes a first sidewall portion 31 positioned in the first half portion 11 and a second sidewall portion 32 positioned in the second half portion 12. The tread portion 4 extends over the first half portion 11 and the second half portion 12. As described in detail below, a communication device 9 is embedded in the first sidewall portion 31 of the first half portion 11 of the tire 1.

The tire 1 includes a pair of bead cores 5 arranged respectively in the pair of bead portions 2, a carcass 6 comprising one or more plies that extend toroidally between the pair of bead cores 5, and a belt 7 comprising one or more belt layers arranged on the tire radial direction outer side of a crown region of the carcass 6. The pair of bead cores 5 includes a first bead core 51 positioned in the first half portion 11 and a second bead core 52 positioned in the second half portion 12.

The bead cores 5 (respectively the first bead core 51 and the second bead core 52) comprise annular cable beads that extend in the tire circumferential direction. The cross-sectional shape of faces that are perpendicular to an extension direction of the bead cores 5 (the cross-sectional shape in the tire width direction) is circular or approximately circular. However, the cross-sectional shape, in the tire width direction, of the bead cores 5 may be any shape, such as a square shape or a hexagonal shape. The cable beads are, for example, formed from high-carbon steel wire covered with rubber. A bead filler 8 formed from a rubber material or the like is disposed on the tire radial direction outer side of the bead cores 5. The bead filler 8 includes a first bead filler 81 positioned in the first half portion 11 and a second bead filler 82 positioned in the second half portion 12.

In a cross section in the tire width direction of the tire 1, the first bead filler 81 is longer, in the tire radial direction, than the second bead filler 82. More specifically, a length L1, in the tire radial direction, of the first bead filler 81 is longer than a length L2, in the tire radial direction, of the second bead filler 82. Accordingly, the rigidity of the first sidewall portion 31 of the first half portion 11, in which the communication device 9 is embedded, can be improved. On the other hand, by keeping the length of the second bead filler 82 in the second half portion 21 shorter, any gain in weight of the tire 1 due to the embedding of the communication device 9 can be suppressed.

The carcass 6 comprises the one or more plies (one in the present embodiment) that extend toroidally between the first bead core 51 and the second bead core 52. The plies are formed from multiple cords covered with rubber. In the present embodiment, the cords that form the plies are, for example, organic fiber cords such as nylon cords. Accordingly, the carcass 6 becomes less likely to interfere with the communication of the communication device 9 compared to a case in which the plies are formed from metal cords. However, the cords that form the plies may be formed from any material and may be, for example, metal cords such as steel cords. In the present embodiment, the cords are arranged to extend in the tire width direction in the tread portion 4. That is, the carcass 6 has a radial structure. The carcass 6 is fastened to the pair of bead cores 5.

Specifically, the carcass 6 includes a carcass body portion 6A, a first carcass foldback portion 61B, and a second carcass foldback portion 62B. The carcass body portion 6A extends toroidally between the first bead core 51 and the second bead core 52. The first carcass foldback portion 61B extends from the carcass body portion 6A, folds back around a perimeter of the first bead core 51 from the tire width direction inner side to the tire width direction outer side, and extends to the tire radial direction outer side. The second carcass foldback portion 62B extends from the carcass body portion 6A, folds back around a perimeter of the second bead core 52 from the tire width direction inner side to tire width direction outer side, and extends to the tire radial direction outer side.

In a cross section in the tire width direction of the tire 1, the first carcass foldback portion 61B is longer, in the tire radial direction, than the second carcass foldback portion 62B. That is, a first end 61E of the tire radial direction outer side of the first carcass foldback portion 61B is positioned further to the tire radial direction outer side than a second end 62E of the tire radial direction outer side of the second carcass foldback portion 62B.

The belt 7 is arranged on the tire radial direction outer side of the crown region of carcass 6. The belt 7 is formed from one or more belt layers (two in the present embodiment) layered in the tire radial direction in the tire equatorial plane CL. For the tread portion 4, the belt 7 is disposed so as to cover the carcass 6 from the tire radial direction outer side. The belt 7 extends over the first half portion 11 and the second half portion 12. In the present specification, of the one or more belt layers, the belt layer having a length that is longest in the tire width direction is also referred to as a “maximum width belt layer”. The ends 7E of the tire width direction outer side of the maximum width belt layer of the belt 7 are also referred to simply as the ends 7E of the tire width direction outer side of the belt 7. In the present embodiment, of the two belt layers, the belt layer of the tire radial direction inner side is the maximum width belt layer. However, the maximum width belt layer is not necessarily the belt layer that is innermost in the tire radial direction. When the belt 7 is formed from one belt layer, the maximum width belt layer specifies this one belt layer.

The communication device 9 is disposed in the tire 1.

The communication device 9 communicates wirelessly. The communication device 9 is, for example, an RF (radio frequency) tag. The RF tag may also be referred to as an RFID (Radio Frequency Identification) tag. The communication device 9 includes an IC (integrated circuit) chip that forms a controller and a memory unit, and one or more antennas connected to the IC chip. The IC chip may store any information relating to the tire 1, such as identification information and the date of manufacture of the tire 1. For example, the communication device 9 has two antennas extending linearly, in a wavy shape, or in a spiral shape. The two antennas are disposed so as to extend in opposite directions from the IC chip, and the device as a whole may have a longitudinal shape.

The IC chip may be operated by a dielectric electromotive force generated by electromagnetic waves received by the one or more antennas. That is, the communication device 9 may be a passive communication device. Alternatively, the communication device 9 may further include a battery and be able to communicate by generating electromagnetic waves under its own power. That is, the communication device 9 may be an active communication device.

The communication device 9 is embedded in the first sidewall portion 31 of the first half portion 11. Specifically, the communication device 9 is embedded in the first sidewall portion 31 of the first half portion 11, further to the tire radial direction inner side than the first end 61E of the first carcass foldback portion 61B and further to the tire radial direction outer side than the second end 62E of the second carcass foldback portion 62B. Accordingly, by virtue of the first carcass foldback portion 61B extending in the first sidewall portion 31 of the first half portion 11 to the tire radial direction outer side, further than the position in which the communication device 9 is embedded, the rigidity of the first sidewall portion 31 in the vicinity of the communication device 9 is increased. Therefore, for example, any out-of-plane deformation to the tire width direction outer side in the first sidewall portion 31 can be suppressed when a load in the tire radial direction is applied to the tire 1. Accordingly, the durability of the communication device 9 embedded in the first sidewall portion 31 of the first half portion 11 is improved. At this time, the length of the second carcass foldback portion 62B in the second half portion 12, in which the communication device 9 is not embedded, is not the same as that of the first carcass foldback portion 61B, and by keeping the length of the second carcass foldback portion shorter, the weight gain of the tire 1 due to the embedding of the communication device 9 can be suppressed.

Then, by virtue of the first carcass foldback portion 61B of the first half portion 11 extending to the tire radial direction outer side, the anti-cut resistance of the first half portion 11 is improved. This is also effective in improving the durability of the first half portion 11 on the vehicle installation outer side, which is more likely to contact obstacles such as curbstones or small stones while the vehicle is in motion. Further, by embedding the communication device 9 further to the tire radial direction outer side than the second end 62E of the second carcass foldback portion 62B, the second carcass foldback portion 62B is not arranged at positions in the second half portion 12 that are on the vehicle installation inner side from the communication device 9. Accordingly, the second half portion 12 becomes less likely to interfere with the communication of the communication device 9 when the communication device 9 communicates with an electronic device positioned on the vehicle installation inner side of the tire 1. In the present embodiment, the communication device 9 is described as being completely embedded in the tire 1. However, the communication device 9 being embedded in the tire 1 can encompass at least a part of the communication device 9 being embedded in the tire 1.

The first end 61E of the tire radial direction outer side of the first carcass foldback portion 61B is positioned further to the tire width direction inner side than the end 7E of the tire width direction outer side of the belt 7 in the first half portion 11. That is, an envelope structure is employed in the first half portion 11 of the carcass 6. In the present embodiment, the first end 61E of the first carcass foldback portion 61B is positioned further to the tire radial direction outer side than the carcass body portion 6A and is positioned further to the tire radial direction inner side than the belt 7. Thus, by virtue of the first carcass foldback portion 61B extending over the entirety of the first sidewall portion 31, the rigidity of the first sidewall portion 31 is increased compared to a configuration in which the first carcass foldback portion 61B terminates in the middle of the first sidewall portion 31. Accordingly, the durability of the communication device 9 embedded in the first sidewall portion 31 of the first half portion 11 is further improved.

The communication device 9 is embedded in the first sidewall portion 31 of the first half portion 11, further to the tire width direction outer side than the first carcass foldback portion 61B. Accordingly, when the communication device 9 communicates with an electronic device positioned on the vehicle installation outer side of the tire 1, the carcass 6 does not interfere with the communication performance of the communication device 9, and the communication performance of the communication device 9 is improved.

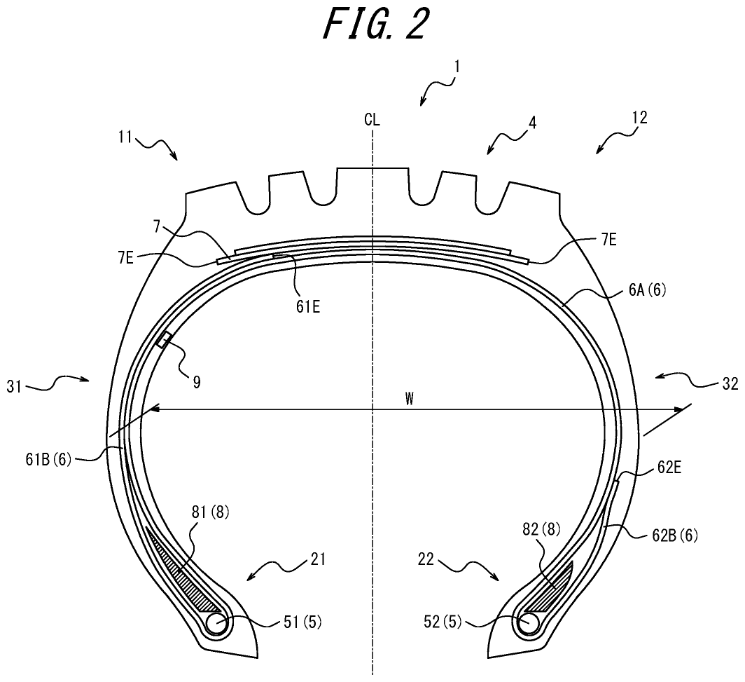

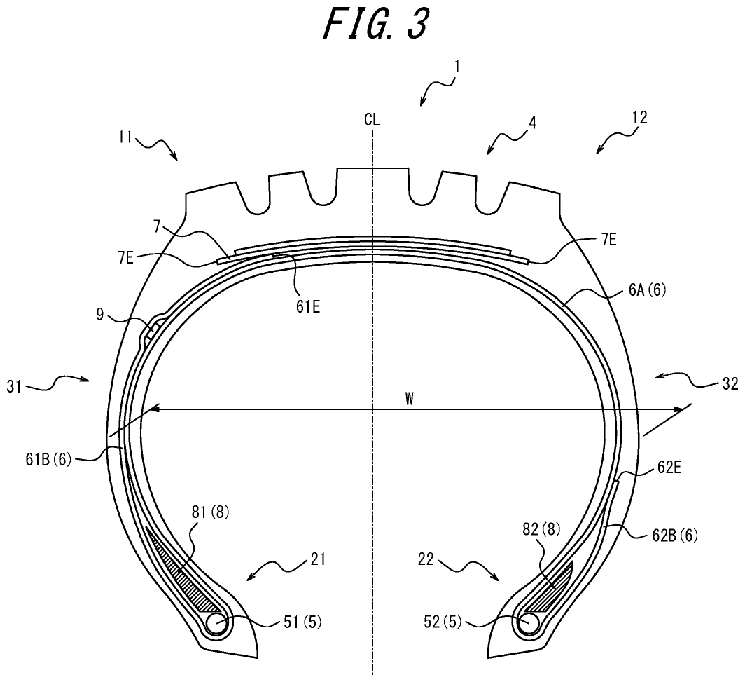

However, the position where the communication device 9 is embedded in the first sidewall portion 31 of the first half portion 11 is not limited to the example shown in FIG. 1. FIG. 2 and FIG. 3 illustrate an example of a modification to the tire 1 in which the position where the communication device 9 is embedded has been changed. FIG. 2 is a cross-sectional view, in the tire width direction, of a first example of a modification to the tire 1 illustrated in FIG. 1. FIG. 3 is a cross-sectional view, in the tire width direction, of a second example of a modification to the tire 1 illustrated in FIG. 1.

For example, as illustrated in FIG. 2, the communication device 9 may be embedded in the first sidewall portion 31 of the first half portion 11, further to the tire width direction inner side than the carcass body portion 6A. Generally, when a load in the tire radial direction is applied to tire 1, the sidewall portions 3 bend to the tire width direction outer sides. At this time, in the sidewall portions 3, a stretching deformation in the tire radial direction occurs closer to the tire width direction outer side, and a compression deformation in the tire radial direction occurs closer to the tire width direction inner side. Because the communication device 9 is particularly susceptible to damage when tensile strain is applied to the communication device 9, by embedding the communication device 9 further to the tire width direction inner side than the carcass body portion 6A, the communication device 9 becomes less susceptible to damage when a load in the tire radial direction is applied to the tire 1.

Alternatively, as illustrated in FIG. 3, the communication device 9 may be embedded in the first sidewall portion 31 of the first half portion 11, further to the tire width direction outer side than the carcass body portion 6A and further to the tire width direction inner side than the first carcass foldback portion 61B. By covering the inner side and the outer side of the communication device 9 in the tire width direction with the carcass body portion 6A and the first carcass foldback portion 61B, respectively, the communication device 9 is less susceptible to being damaged by an impact from an outer surface or an inner surface of the tire 1.

Referring again to FIG. 1, the communication device 9 is positioned in the first sidewall portion 31 of the first half portion 11, further to the tire radial direction outer side than a position of the tire maximum width W. Here, the position of the “tire maximum width W” is a position where the length of the tire 1 in the width direction is longest when the tire 1 is in the standard state, i.e., fitted to an applicable rim, a prescribed internal pressure is applied, and no load is applied. Accordingly, other parts of the tire 1 become less likely to interfere with the communication of the communication device 9 when the communication device 9 communicates with electronic devices positioned further to the tire radial direction outer side than the tire 1, such as a road surface. Therefore, it is possible to balance the communication performance of the communication device 11 in the tire radial direction with the communication performance of the communication device 11 in the tire width direction.

On the other hand, the communication device 9 may be positioned in the first sidewall portion 31 of the first half portion 11, further to the tire radial direction inner side than the position of the tire maximum width W. When embedding the communication device 9 further to the tire radial direction inner side of the tire than the position of the tire maximum width W, obstacles such as curbstones or small stones become less likely to strike the outer surface of the embedded position of the communication device 9. Therefore, the communication device 9 is less susceptible to damage.

### Second Embodiment

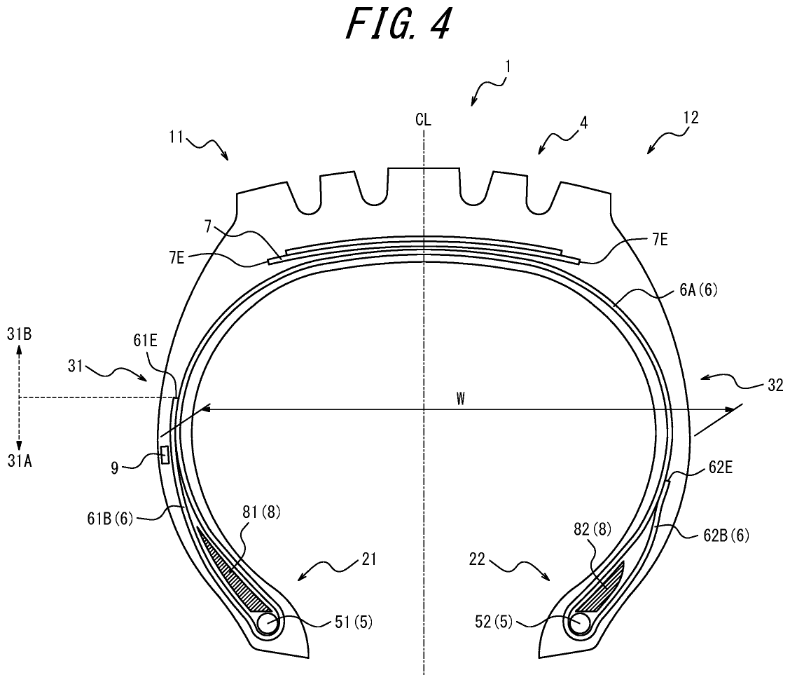

The following describes a tire 1 according to a second embodiment of the present disclosure, with reference to FIG. 4. FIG. 4 is a cross-sectional view, cut along the tire width direction, of the tire 1 according to the second embodiment of the present disclosure.

As illustrated in FIG. 4, the position of the first end 61E of the tire radial direction outer side of the first carcass foldback portion 61B in the second embodiment is different from that in the first embodiment. The following describes the second embodiment, focusing on the differences from the first embodiment. Portions that have the same configuration as in the first embodiment use the same reference signs.

In the second embodiment, as in the first embodiment, in the cross section in the tire width direction of the tire 1, the first carcass foldback portion 61B is longer, in the tire radial direction, than the second carcass foldback portion 62B. More specifically, the first end 61E of the tire radial direction outer side of the first carcass fold 61B is positioned further to the tire radial direction outer side than the second end 62E of the tire radial direction outer side of the second carcass foldback portion 62B. Further, the communication device 9 is embedded in the first sidewall portion 31 of the first half portion 11.

In the present embodiment, the first end 61E of the tire radial direction outer side of the first carcass foldback portion 61B is positioned further to the tire width direction outer side than the end 7E of the tire width direction outer side of the belt 7 in the first half portion 11. That is, the first sidewall portion 31 includes, in the tire radial direction, an inner portion 31A, in which the first carcass foldback portion 61B of the carcass 6 is arranged, and an outer portion 31B, in which the first carcass foldback portion 61B is not arranged. The inner portion 31A of the first sidewall portion 31 is more rigid than the outer portion 31B due to the first carcass foldback portion 61B being arranged therein. Thus, for example, when a load in the tire radial direction is applied to the tire 1, due to the difference in rigidity between the inner portion 31A and the outer portion 31B of the first sidewall portion 31, the outer portion 31B of the first sidewall portion 31 is more susceptible to bending and the inner portion 31A is less susceptible to bending. Accordingly, any out-of-plane deformation to the tire width direction in the inner portion 31A of the first sidewall portion 31 is suppressed. Thus, by embedding the communication device 9 in the inner portion 31A of the first sidewall portion 31, where the first carcass foldback portion 61B is arranged, the communication device 9 becomes less susceptible to damage. In the illustrated example, the first end 61E of the tire radial direction outer side of the first carcass foldback portion 61B is positioned near the position of the tire maximum width W. However, the first end 61E of the tire radial direction outer side of the first carcass foldback portion 61B may be at any position in the tire radial direction that is further to the tire width direction outer side than the second end 62E of the tire radial direction outer side of the second carcass foldback portion 62B.

In the present embodiment, the communication device 9 is embedded on the tire width direction outer side of the first carcass foldback portion 61B of the carcass 6. However, as in the first embodiment, the communication device 9 may be embedded in the first sidewall portion 31 of the first half portion 11, further to the tire width direction inner side than the carcass body portion 6A. Alternatively, the communication device 9 may be embedded in the first sidewall portion 31 of the first half portion 11, further to the tire width direction outer side than the carcass body portion 6A and further to the tire width direction inner side than the first carcass foldback portion 61B.

In the present embodiment, the communication device 9 is positioned in the first sidewall portion 31 of the first half portion 11, further to the tire radial direction inner side than the position of the tire maximum width W. However, as in the first embodiment, the communication device 9 may be positioned in the first sidewall portion 31 of the first half portion 11, further to the tire radial direction outer side than the position of the tire maximum width W.

As described above, the tire 1 according to each embodiment of the present disclosure includes the first half portion 11 on the vehicle installation outer side and the second half portion 12 on the vehicle installation inner side with respect to the tire equatorial plane CL and comprises a carcass 6 that extends between a first bead core 51 positioned in the first half portion 11 and a second bead core 52 positioned in the second half portion 12. The carcass 6 comprises a carcass body portion 6A that extends toroidally between the first bead core 51 and the second bead core 52, a first carcass foldback portion 61B that extends from the carcass body portion 6A, folds back around a perimeter of the first bead core 51 from the tire width direction inner side to the tire width direction outer side, and extends to the tire radial direction outer side, and a second carcass foldback portion 62B that extends from the carcass body portion 6A, folds back around a perimeter of the second bead core 52 from the tire width direction inner side to the tire width direction outer side, and extends to the tire radial direction outer side. The first end 61E of the tire radial direction outer side of the first carcass foldback portion 61B is positioned further to the tire radial direction outer side than the second end 62E of the tire radial direction outer side of the second carcass foldback portion 62B. The communication device 9 is embedded in a sidewall portion 31 of the first half portion 11, further to the tire radial direction inner side than the first end 61E and further to the tire radial direction outer side than the second end 62E. Such a configuration can improve the durability of the communication device 9 disposed in the first sidewall portion 31 of the first half portion 11 while suppressing the weight gain of the tire 1 by keeping the length of the second carcass foldback portion 62B in the second half portion 12 shorter.

The tire 1 according to each embodiment of the present disclosure further includes a belt 7 arranged on the tire radial direction outer side of the crown region of the carcass 6, and the first end 61E of the first carcass foldback portion 61B is preferably positioned further to the tire width direction inner side than the end 7E of the tire width direction outer side of the belt 7 in the first half portion 11. Such a configuration increases the rigidity of the first sidewall portion 31 of the first half portion 11 compared to a configuration in which the first carcass foldback portion 61B terminates in the middle of the first sidewall portion 31. Accordingly, the durability of the communication device 9 embedded in the first sidewall portion 31 of the first half portion 11 is further improved.

The tire 1 according to each embodiment of the present disclosure further includes a belt 7 arranged on the tire radial direction outer side of the carcass body portion 6A, and the first end 61E of the first carcass foldback portion 61B is preferably positioned further to the tire width direction outer side than the end 7E of the tire width direction outer side of the belt 7 in the first half portion 11. When a load in the tire radial direction is applied to the tire, such a configuration suppresses any out-of-plane deformation in the first sidewall portion 31 of the first half portion 11 to the tire width direction of the inner portion 31A, in which the first carcass foldback portion 61B is arranged. Accordingly, the communication device 9 embedded in the first sidewall portion 31 of the first half portion 11 becomes less susceptible to damage.

In the tire 1 according to each embodiment of the present disclosure, the communication device 9 is preferably embedded in the first sidewall portion 31 of the first half portion 11, further to the tire width direction outer side than the first carcass foldback portion 61B. Such a configuration improves the communication performance of the communication device 9 when the communication device 9 communicates with an electronic device positioned on the vehicle installation outer side of the tire 1.

In the tire 1 according to the first embodiment of the present disclosure, the communication device 9 is preferably embedded in the first sidewall portion 31 of the first half portion 11, further to the tire width direction inner side than the carcass body portion 6A. Such a configuration makes the communication device 9 less susceptible to being damaged when a load in the tire radial direction is applied to the tire 1.

In the tire 1 according to the first embodiment of the present disclosure, the communication device 9 is preferably embedded in the first sidewall portion 31 of the first half portion 11, further to the tire width direction outer side than the carcass body portion 6A and further to the tire width direction inner side than the first carcass foldback portion 61B. Such a configuration makes the communication device 9 less susceptible to being damaged by an impact from the outer surface or the inner surface of the tire 1.

Note that although the tire according to the present disclosure has been described based on the drawings and embodiments, a person skilled in the art can make various modifications and adjustments based on the present disclosure. Thus, these modifications and adjustments are included in the scope of the present disclosure. For example, the configuration, functions, or the like included in each embodiment can be re-arranged not to be logically inconsistent. The configuration, functions, or the like included in each embodiment can be used in combination with other embodiments, and multiple configurations, functions, or the like can be combined into one, divided, or partially omitted.

### REFERENCE SIGNS LIST

1: tire, 11: first half portion, 12: second half portion, 2: bead portion, 21: first bead portion, 22: second bead portion, 3: sidewall portion, 31: first sidewall portion, 32: second sidewall portion, 4: tread portion, 5: bead core, 51: first bead core, 52: second bead core, 6: carcass, 6A: carcass body portion, 61B: first carcass foldback portion, 62B: second carcass foldback portion, 61E: end of first carcass foldback portion, 62E: end of second carcass foldback portion, 7: belt, 7E: end of belt, 8: bead filler, 81B: first bead filler, 82B: second bead filler, 9: communication device, CL: tire equatorial plane, W: tire maximum width, L1: length of first bead filler, L2: length of second bead filler

1. A tire including a first half portion on a vehicle installation outer side and a second half portion on a vehicle installation inner side, with respect to a tire equatorial plane, the tire comprising:
a carcass that extends between a first bead core positioned in the first half portion and a second bead core positioned in the second half portion,
the carcass comprising:
a carcass body portion that extends toroidally between the first bead core and the second bead core;
a first carcass foldback portion that extends from the carcass body portion, folds back around a perimeter of the first bead core from a tire width direction inner side to a tire width direction outer side, and extends to a tire radial direction outer side; and
a second carcass foldback portion that extends from the carcass body portion, folds back around a perimeter of the second bead core from the tire width direction inner side to the tire width direction outer side, and extends to the tire radial direction outer side,
wherein a first end of the tire radial direction outer side of the first carcass foldback portion is positioned further to the tire radial direction outer side than a second end of the tire radial direction outer side of the second carcass foldback portion, and
a communication device is embedded in a sidewall portion of the first half portion, further to the tire radial direction inner side than the first end and further to the tire radial direction outer side than the second end.

2. The tire according to claim 1, further comprising a belt arranged on the tire radial direction outer side of a crown region of the carcass,
wherein the first end of the first carcass foldback portion is positioned further to the tire width direction inner side than an end of the tire width direction outer side of the belt in the first half portion.

3. The tire according to claim 1, further comprising a belt arranged on the tire radial direction outer side of the carcass body portion,
wherein the first end of the first carcass foldback portion is positioned further to the tire width direction outer side than an end of the tire width direction outer side of the belt in the first half portion.

4. The tire according to claim 1, wherein the communication device is embedded in the sidewall portion of the first half portion, further to the tire width direction outer side than the first carcass foldback portion.

5. The tire according to claim 1, wherein the communication device is embedded in the sidewall portion of the first half portion, further to the tire width direction inner side than the carcass body portion.

6. The tire according to claim 1, wherein the communication device is embedded in the sidewall portion of the first half portion, further to the tire width direction outer side than the carcass body portion and further to the tire width direction inner side than the first carcass foldback portion.

7. The tire according to claim 2, wherein the communication device is embedded in the sidewall portion of the first half portion, further to the tire width direction outer side than the first carcass foldback portion.

8. The tire according to claim 2, wherein the communication device is embedded in the sidewall portion of the first half portion, further to the tire width direction inner side than the carcass body portion.

9. The tire according to claim 2, wherein the communication device is embedded in the sidewall portion of the first half portion, further to the tire width direction outer side than the carcass body portion and further to the tire width direction inner side than the first carcass foldback portion.

10. The tire according to claim 3, wherein the communication device is embedded in the sidewall portion of the first half portion, further to the tire width direction outer side than the first carcass foldback portion.

11. The tire according to claim 3, wherein the communication device is embedded in the sidewall portion of the first half portion, further to the tire width direction inner side than the carcass body portion.

12. The tire according to claim 3, wherein the communication device is embedded in the sidewall portion of the first half portion, further to the tire width direction outer side than the carcass body portion and further to the tire width direction inner side than the first carcass foldback portion.
